(19) United States
(12) Patent Application Publication
(10) Pub. No.: US 2004/0257626 A1
(43) Pub. Date: Dec. 23, 2004

(54) Scanner apparatus for scanning bank checks

(75) Inventors: Ugo Panini, Torino (IT); Franco Bellotto, Moncalieri (IT)

Correspondence Address: SEED INTELLECTUAL PROPERTY LAW GROUP PLLC, 701 FIFTH AVE, SUITE 6300, SEATTLE, WA, 98104-7092, US

(73) Assignee: PANINI S.p.A., Torino (IT)

(21) Appl. No.: 10/787,821

(22) Filed: Feb. 26, 2004

(30) Foreign Application Priority Data
Feb. 27, 2003 (IT) TO2003U000032

(51) Int. Cl. H04N 1/04

(52) U.S. Cl. 358/474; 358/498

(57) ABSTRACT

The apparatus comprises an input receptacle for receiving one or more checks to be scanned, an image-scanner unit for scanning a check, an output receptacle for receiving a check after it has been scanned, a conveyor mechanism for conveying checks, one at a time, from the input receptacle to the output receptacle along a path extending in front of the scanning unit, and a casing containing the scanner unit and the conveyor mechanism. The scanner unit is mounted so as to be movable relative to the casing between a normal operative position in which it faces the path of the checks, and a position to which it is moved away from the path of the checks to permit cleaning of the scanner unit or removal of jammed checks.

### BACKGROUND OF THE INVENTION

1. Field of the Invention

The present invention relates to a scanner apparatus for scanning bank checks. The apparatus is intended for use, particularly but not exclusively, at a bank counter.

2. Description of the Related Art

Currently, there are known types of scanning apparatus for scanning bank checks which comprise an input receptacle for receiving one or more checks to be scanned. The apparatus comprises a rigid outer casing and a conveyor mechanism for conveying the checks, one at a time, from the input receptacle to an output receptacle, the checks following a substantially U-shaped path and passing in front of an image-scanner device for scanning one or both faces of the check. The scanner device usually comprises a pair of substantially symmetrical image-scanner units which are arranged on either side of the path followed by the checks in order to scan both faces (front and rear) of the checks. Each scanner unit has a CIS (compact image sensor) optical sensor which needs to be cleaned periodically.

### BRIEF SUMMARY OF THE INVENTION

The object of the present invention is to enable operations to clean the scanner units in an apparatus of the type identified above to be performed more easily and quickly.

Another object of the invention is to facilitate the removal of checks or portions thereof which sometimes remain jammed in the image-scanner device.

These and other objects and advantages which will be explained further below are achieved, according to the present invention, by a scanner apparatus having the characteristics defined in the appended claims.

### BRIEF DESCRIPTION OF THE SEVERAL VIEWS OF THE DRAWINGS

A preferred but non-limiting embodiment of the invention will now be described with reference to the appended drawings, in which:

FIG. 1 is an overall perspective view of a scanner apparatus according to the invention,

FIG. 2 is a plan view of the inner parts of the apparatus of FIG. 1,

FIG. 3 is an enlarged view of a detail of FIG. 2, and

FIGS. 4 and 5 are perspective views which illustrate the scanner device in an operative or closed position, and in an open position for inspection or cleaning of the sensors of the scanner device.

### DETAILED DESCRIPTION OF THE INVENTION

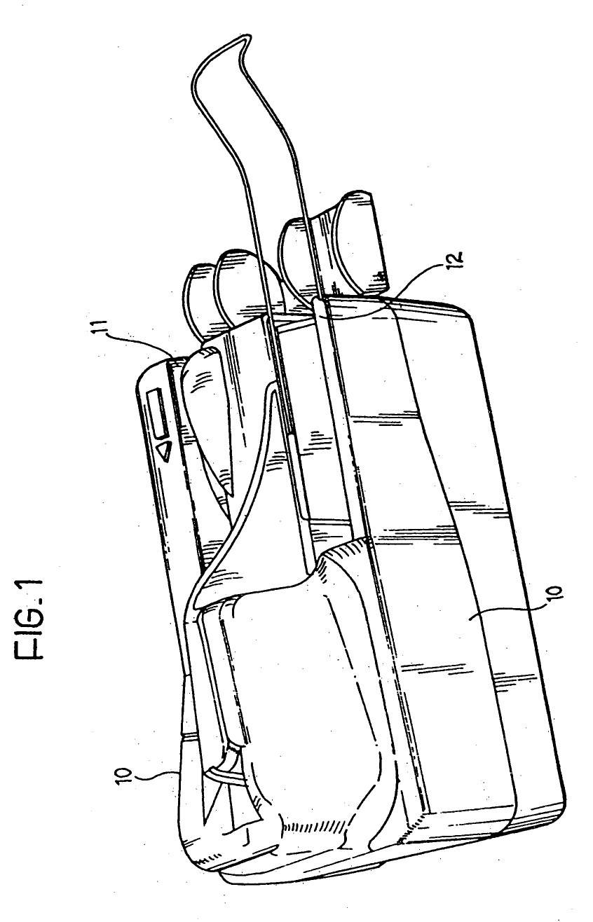

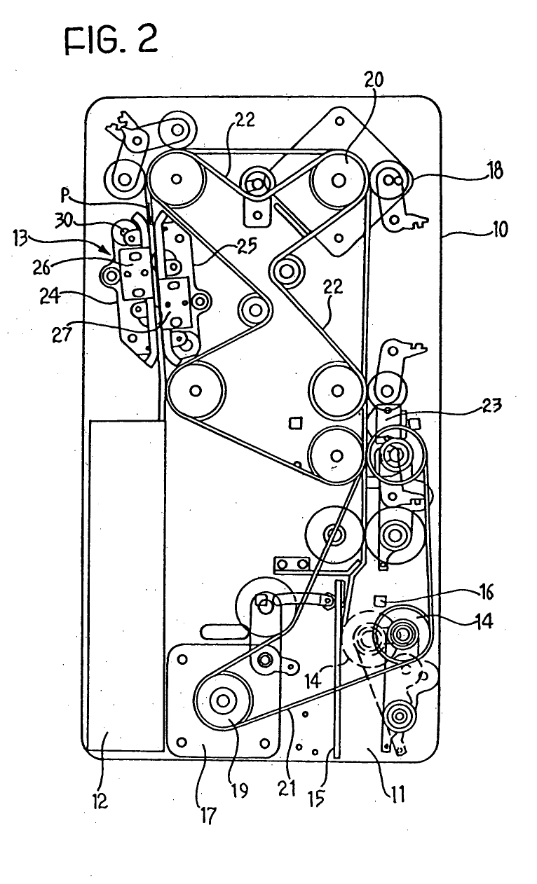

With reference initially to FIGS. 1 and 2, a scanner apparatus for scanning checks comprises an outer casing 10 which forms at the top an input receptacle 11 in which one or more checks to be scanned (not shown) are arranged vertically.

The apparatus comprises a conveyor mechanism of known type for conveying the checks, one at a time, from the input receptacle 11 to an output receptacle 12, the checks following a substantially U-shaped path and passing in front of an image-scanner device, generally indicated 13 (and described in greater detail below), for scanning one or both faces of the check.

The constructional and functional characteristics of the conveyor mechanism (which may be of any known type) are not relevant per se for the purposes of an understanding of the invention and are not therefore described in detail herein.

Extremely briefly, the checks are picked up from the input receptacle 11 by a pick-up and feed roller 14 which cooperates with a feed plate 15. A photocell 16 detects the presence of a check in the input receptacle and activates two motors 17, 18 which, by means of motor-driven rollers 19, 20, set two respective transmission belts 21, 22 in circulation; the belts 21, 22 bring about forward movement of one check at a time, causing the check to pass in front of a head 23 for reading magnetic characters printed on the front of the check. The check passes through the scanner device 13 following a path P which extends between a pair of substantially symmetrical image-scanner units 24, 25 each provided with a respective CIS (compact image sensor) optical sensor 26, 27 for scanning both faces (front and rear) of the check. The CIS optical sensors are known in the art and do not need to be described in detail herein.

An upper portion of the casing 10, that is, the portion which encloses the scanner device 13, is removable from the rest of the casing to allow an operator to have access to the scanner units in order to clean the CIS sensors and/or to remove any checks or fragments of checks that have remained jammed between them.

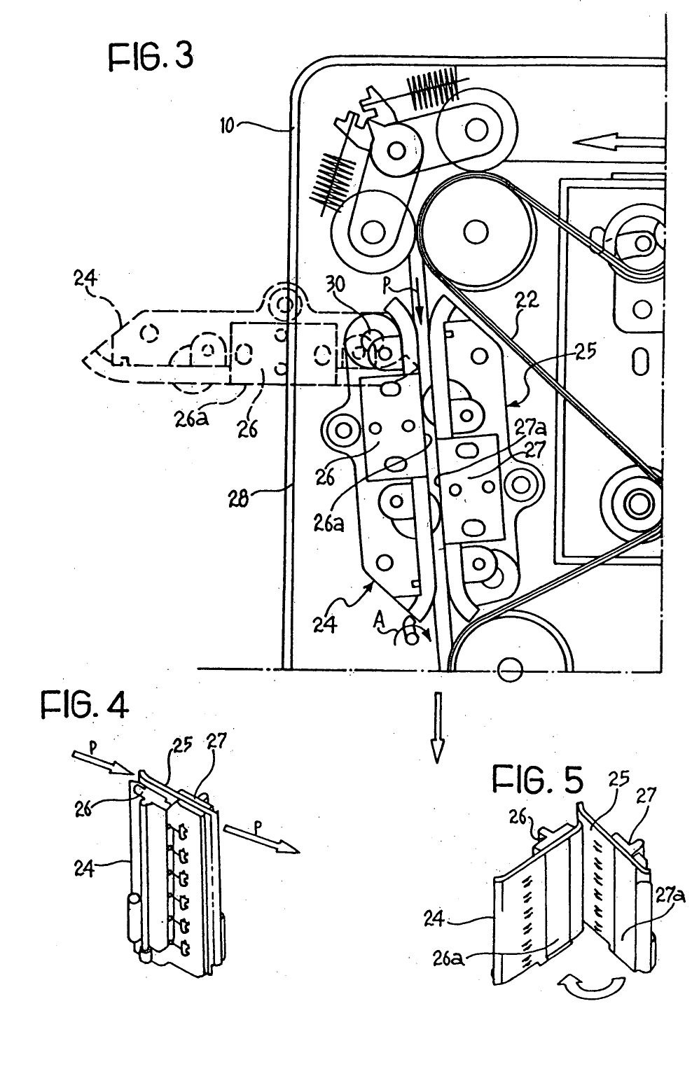

With reference now to FIGS. 3, 4 and 5, according to the present invention, the outer scanner unit 24, that is, that which is closest to the outer wall of the casing 10, is mounted so as to be pivotable relative to the casing about a vertical pin 30 so that it can be moved from a normal operation position (shown in FIG. 4 and in solid outline in FIG. 3), in which the CIS sensor 26 faces the inner scanning unit 25, to an open position (shown in FIG. 5 and in broken outline in FIG. 3) in which the glass surfaces 26a, 27a of both CIS sensors can be reached and cleaned easily after the removable portion of the casing has been taken off.

In its normal operation position, shown in solid outline in FIG. 3, the outer scanner unit 24 is restrained by a resilient retaining element such as, for example, a tooth 32 which is urged resiliently in the locking direction indicated by the arrow A.

As will be appreciated, in comparison with conventional scanning apparatus comprising a monolithic casing and scanner units that are mounted in a fixed manner, the apparatus according to the present invention renders operations to inspect and/or clean the CIS sensors and the removal of jammed checks easier, quicker and less expensive.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

The invention is not intended to be limited to the embodiment described and illustrated herein, which should be considered as an example of an embodiment of the scanner apparatus; rather, the invention may be modified with regard to the form and arrangement of parts and to the details of construction and of operation. For example, although in the preferred embodiment shown in the drawings, the check scanning device 13 comprises two facing scanner units for the front/rear scanning of both faces of a check, the invention is equally applicable to scanner apparatus having a single scanner unit or two scanner units which are offset (rather than facing as a pair) along the path followed by the checks.

1. A scanner apparatus for scanning bank checks, comprising:
an input receptacle for receiving at least one check to be scanned,
at least one first image-scanner unit for scanning at least one of the faces of the check,
an output receptacle for receiving the check after it has been scanned by the first scanner unit,
a conveyor mechanism for conveying checks, one at a time, from the input receptacle to the output receptacle along a path extending in front of the scanning unit, and
a casing containing the scanner unit and the conveyor mechanism,
wherein the at least one scanner unit is mounted so as to be movable relative to the casing in order selectively to adopt:
a first, normal operative position in which it faces the path of the checks, and
a second position to which it is moved away from the path of the checks.

2. The scanner apparatus according to claim 1, of the type comprising a first image-scanner unit and a second image-scanner unit facing one another on opposite sides of the path in order to scan both faces of a check, wherein the first scanner unit, which is closer to the casing, is mounted so as to be movable relative to the casing in order selectively to adopt:
a first, normal operative position in which it faces the second scanner unit, and
a second position to which it is moved away from the second scanner unit.

3. The scanner apparatus according to claim 1 wherein the scanner unit is associated with a retaining element which is mounted on the fixed portion of the apparatus in order to releasably restrain the scanner unit in the said first position.

4. The scanner apparatus according to claim 1 wherein the scanner unit is mounted so as to be pivotable about an axis which is substantially fixed relative to the rest of the apparatus.

5. The scanner apparatus according to claim 1 wherein a portion of the casing located beside the scanner unit is releasably fixed to the rest of the casing.
